(19) United States
(12) Patent Application Publication
(10) Pub. No.: US 2024/0320308 A1
(43) Pub. Date: Sep. 26, 2024

(54) APPARATUS AND METHOD FOR CODE RANDOMIZATION OF UNMODIFIED BINARIES ON INTEL SGX ENCLAVE

(71) Applicant: ELECTRONICS AND TELECOMMUNICATIONS RESEARCH INSTITUTE, Daejeon (KR)

(72) Inventors: Woomin HWANG, Daejeon (KR); Sung-Jin KIM, Daejeon (KR); Inhyeok JANG, Daejeon (KR); Byung Chul BAE, Daejeon (KR); Byungjoon KIM, Daejeon (KR)

(21) Appl. No.: 18/218,320

(22) Filed: Jul. 5, 2023

(30) Foreign Application Priority Data
Mar. 21, 2023 (KR) 10-2023-0036852

(51) Int. Cl. G06F 21/14; G06F 21/60; G06F 21/74

(52) U.S. Cl. CPC G06F 21/14; G06F 21/602; G06F 21/74

(57) ABSTRACT

Disclosed herein are an apparatus and method for code randomization in a confidential execution region based on Intel Software Guard eXtensions (SGX) for a user application and a shared library. The method may include initializing a confidential execution region by executing an SGX enclave shared object file generated and distributed by a publisher device, loading an encrypted payload into memory, acquiring a decryption key for decrypting the encrypted payload, decrypting the payload, and placing the decrypted payload in the confidential execution region in units of basic blocks with reference to metadata distributed by the publisher device.

### CROSS REFERENCE TO RELATED APPLICATION

This application claims the benefit of Korean Patent Application No. 10-2023-0036852, filed Mar. 21, 2023, which is hereby incorporated by reference in its entirety into this application.

### BACKGROUND OF THE INVENTION

### 1. Technical Field

The disclosed embodiment relates generally to technology for reducing attempts to leak the pattern of memory access made at the time of executing the payload of a target shared library and to thereby steal context information of currently executed code and data in a confidential execution environment in which, without modifying a binary executed by a user, the executable file or a shared library file is capable of being executed on encrypted memory called an ‘enclave’ using Intel's Software Guard extensions (SGX) technology, and more particularly to environment configuration and dynamic execution technology through which, although code is partitioned and relocated for protection the execution context of the code, the code is executed the same as before the relocation.

### 2. Description of Related Art

General applications running at a user level operate based on trust in an operating system (OS) and a hypervisor that provide an execution platform in native and cloud environments. Therefore, a host is able to check all of the information of the applications with administrator's access permission or the like from the viewpoint of the system.

However, general applications are vulnerable not only to attacks that steal critical data by discovering vulnerabilities in the binary code of a target application through static reverse-engineering analysis and repeated dynamic reverse-engineering analysis but also to attacks in which a malicious user/administrator steals data by accessing memory with higher-level access permission such as that of an OS or a hypervisor. Particularly, in a general computing environment in which code and data have to be in the form of decrypted plaintext in memory at a specific time for execution thereof, it is difficult to respond to an attack that extracts critical information, such as keys used for encryption/decryption, by analyzing data by accessing the physical memory used by a target program after taking high-level permission. Further, with the advance and popularization of cloud platforms, an increase in data leakage and vulnerabilities causing an escape from an isolated region, which use multi-tenant characteristics of a cloud, raises the need to solve these problems.

In order to solve the above-mentioned problems, many CPU manufacturers have proposed methods for performing a desired operation without exposing content stored in the designated memory of a user in response to a malicious program peeking the memory while running at the same user level or to a malicious user or administrator in an OS, a hypervisor, or the like.

For example, Intel commercialized Software Guard extensions (SGX), which protects user information by trusting only a CPU and causing code and data stored in a designated encrypted memory region to be decrypted and used only in the CPU, and AMD commercialized Secure Encrypted Virtualization (SEV), which protects data by isolating memory of each virtual machine by encrypting a used memory region for each virtual machine. Also, ARM commercialized TrustZone with a purpose similar to the purposes of these technologies.

Among the above-mentioned technologies, Intel's SGX is a data protection and execution protection technology that does not expose execution information and data of an application to the outside by allocating a designated region of a process in an encrypted memory region such that disallowed access to the corresponding memory region is made meaningless. This technology, which can be used also in a cloud environment, intends to prevent information exposure in such a way that data stored in an encrypted region is allowed to be in a decrypted state only in a CPU occupied by the corresponding process such that unapproved access to physical memory results in acquisition of meaningless encrypted data.

However, in order to protect code and data of a user by applying Intel's SGX, it is necessary to solve various problems.

First, in order to enable a program to be executed inside SGX enclave memory, a process of changing a target program to a program using an SGX SDK by modifying the source code of the target program or a process of linking the source code with an SGX library by recompiling the same is required. However, because most programs or executable binaries that a user wants to protect do not have versions ported using SGX technology or because the source code thereof is not open to the public, it is difficult to convert the program.

As a partial solution to this problem, some studies have proposed a method for loading a user binary into SGX enclave memory without change, but because the relative location of code in the binary is not changed, the locations of important code and data that are fixed relative to the start memory address of the binary may be exposed.

Particularly, when identification of the pattern of access to specific code included in the binary and acquisition of the memory address of the code are performed using an external monitoring technique, which will be described later, a malicious user combines the acquired information with a result of reverse-engineering analysis performed on the disclosed code, thereby predicting the location of the code intended to be monitored.

For example, in a binary, the code of which is open to the public (e.g., a shared library), the memory location of code implemented for access to a specific encryption key is detected, and the time point at which the corresponding code is executed at runtime is identified, whereby whether the encryption key is loaded into a CPU may be determined and the information may be stolen.

Also, as a threat of leakage of internal control flow information using an external monitoring technique, several studies have recently suggested SGX controlled channel attacks that raise the possibility of stealing internal confidential information despite the absence of the ownership by predicting information about the location at which code is currently executed through external monitoring by bypassing SGX technology.

General controlled channel attacks restrict access permission by setting a reserved bit in a page table managed by an OS for the physical memory used by an SGX enclave and intentionally cause a page fault when memory access is made in the enclave, thereby collecting necessary information. In this way, malicious attackers combine a sequence of used page frames, which can be identified through successive page faults, with a result of static analysis on the execution code, whereby it is possible to more accurately predict the memory location of the target code, which is generally in the form of a branch point, information about whether the code is executed, and the access pattern and to leak the internal information. For example, COPYCAT published in USENIX Security in 2020 (D. Moghimi et al., “CopyCat: Controlled Instruction-Level Attacks on Enclaves,” USENIX Security 2020) has proposed a controlled channel attack method capable of tracking a branch decision for deciding on a control flow inside a single page frame by acquiring the number of instructions executed in a single enclave code page by estimating the same from outside the enclave. This attack also has an issue in which external monitoring becomes more sophisticated through analysis of known code when the binary and source code running in the enclave are open to the public.

When the repeated execution of enclave code and external monitoring become possible, more sophisticated attacks can be performed by predicting and acquiring Return-Oriented Programming (ROP) gadgets inside an enclave through static analysis of target source code and an enclave file and dynamic analysis using external monitoring, as in the research published in USENIX Security in 2017 (J. Lee et al., “Hacking in Darkness: Return-oriented Programming against Secure Enclaves”, USENIX Security 2017). Therefore, in order to protect internal code and dynamic data generated by execution, it is necessary to reduce leakage of information from an SGX enclave, which is caused by a controlled channel attack and reverse engineering.

In order to protect user code and data from such threats, many studies have been researched.

SGXCrypter published in 2017 (D. Tychalas et al., “SGXCrypter: IP Protection for Portable Executables using Intel's SGX technology,” ASP-DAC 2017) has proposed a program structure for executing an executable file in a Portable Executable (PE) format inside an SGX enclave using Intel's SGX technology, thereby implementing a method for changing the location at which a non-SGX executable program is executed in the enclave. However, the format of a payload is limited to an executable program, and a response to a PE program using a shared library not included therewith, a solution to an execution method when a payload is a shared library, and the like have not been proposed. Further, when this method is used, because a native binary is directly accommodated, the location of main code becomes known when the start address of a binary is exposed, which may result in a controlled channel attack on an enclave by a malicious user/administrator outside the SGX enclave. However, a solution thereto has not been presented.

SGX-Shield published in NDSS in 2017 (J. Seo et al., “SGX-Shield: Enabling Address Space Layout Randomization for SGX Programs,” NDSS 2017) has proposed a method for reducing controlled-channel attacks by implementing Address Space Layout Randomization (ASLR) inside an SGX enclave through multistage program loading in the enclave by changing an enclave program at a compiler level. This is configured to partition code and data present in the enclave into fixed-sized blocks and to change the locations of the blocks. However, a large number of instructions for maintaining a control flow has to be added due to partitioning into fixed-sized blocks, and the size of the block has to be limited to an optimum level in order to reduce performance degradation. Further, there is a disadvantage in which porting an existing binary has to be performed by modifying the source code thereof or recompiling using a changed compiler has to be performed.

DR.SGX published in ACSAC in 2019 (F. Brasser et al., “DR.SGX: automated and adjustable side-channel protection for SGX using data location randomization,” ACSAC 2019) has also proposed a method capable of dynamically changing an address location by changing code to forcibly perform address instrumentation by a compiler and linking the changed address through instrumentation at runtime, but this also requires recompiling and code change. Compiler-assisted Code Randomization published in 2018 (H. Koo et al., “Compiler-assisted Code Randomization,” IEEE S&P 2018) performs randomization on a code region, but has the same disadvantage.

SGX-LEGO published in Elsevier Computers & Security in 2019 (D. Kim et al., “SGX-LEGO: Fine-grained SGX controlled-channel attack and its countermeasure,” Elsevier Computers & Security 2019) has shown the possibility of a version identification attack, which extracts the memory access pattern of internal software by a controlled-channel attack with granularity of a page frame or reduced granularity and then tracks identity of code by comparing the extracted memory access pattern with information in an accumulated memory access pattern database, and as a solution thereto, it has proposed a method of generating a Return-Oriented Programming (ROP) payload by introducing an ROP approach and randomizing page access by executing the ROP payload in the enclave of an SGX application such that the characteristics of the access patterns are not shown. This has an advantage in which high security is achieved by changing a memory access pattern without breaking Data Execution Prevention (DEP), but there is a performance problem in which execution of ROP is about 10 to 20 times slower than execution of an existing enclave.

### SUMMARY OF THE INVENTION

An object of the disclosed embodiment is to protect a program binary that a user intends to protect using SGX technology without modifying or recompiling the source code thereof and to reduce controlled-channel attacks performed by external monitoring, thereby protecting information about internal code execution and data.

Another object of the disclosed embodiment is to thwart an attempt to collect the patterns of access to memory page frames made by execution of a shared library payload loaded onto a confidential execution engine through external monitoring and an attempt to predict internal execution context based on the collected patterns.

A publisher apparatus according to an embodiment includes memory in which at least one program is recorded and a processor for executing the program. The program may include a confidential execution engine generator for receiving a user application execution file or a payload file and generating a Software Guard extensions (SGX) enclave shared object file to be executed in an encrypted SGX enclave, an encrypted payload file, and a user application execution file; and a metadata extractor for analyzing the payload file, segmenting instruction sequences included in a payload into basic blocks, and generating metadata on each of the basic blocks. The SGX enclave shared object file, the encrypted payload file, the user application execution file, and the metadata may be distributed to a cloud node capable of executing at least one SGX enclave.

Here, the confidential execution engine generator may generate a shim layer and bridge code that pass through the boundary of the SGX enclave based on an interface extracted from the payload in order to call external library code other than the payload and an interface exposed from the payload in order to respond to a call from other external code, and may build the shim layer and the bridge code along with a library in the SGX enclave and confidential execution template code, thereby generating the SGX enclave shared object file.

Here, the SGX enclave shared object file may include an in-enclave loader for decrypting an encrypted payload, loading the decrypted payload into an executable memory region in a specified SGX enclave depending on a file format so as to be executable, and relocating a selected payload code block according to a randomization policy and a payload code randomizer for selecting a code block to be moved based on distributed payload metadata, determining a memory location in the enclave to which the selected code block is to be moved, moving the selected code block thereto, and restoring a control flow disconnected by movement of the code block by reconnecting the same using instruction location information specified in inbound/outbound metadata entries of corresponding code blocks.

Here, the metadata on each of the basic blocks may include the range of the basic block represented as a pair of byte offsets from a start point of payload code, a relationship with a predecessor basic block or a successor basic block according to a control flow of the code, the locations of instructions of a designated type in the basic block, and inbound/outbound control flow reference information including the locations of a source instruction and a target instruction that cause movement between the basic blocks.

An apparatus for code randomization in an SGX-based confidential execution region according to an embodiment includes memory in which at least one program is recorded and a processor for executing the program. The program may perform initializing a confidential execution region by executing an SGX enclave shared object file generated and distributed by a publisher apparatus, loading an encrypted payload into memory, and acquiring a decryption key for decrypting the encrypted payload; and decrypting the payload and placing the decrypted payload in the confidential execution region in units of basic blocks with reference to metadata distributed by the publisher apparatus.

Here, when placing the decrypted payload, the program may perform decrypting payload code in enclave memory, initially placing the payload code in the confidential execution region depending on a file format, randomly relocating a part of code blocks of the initially placed payload code based on the metadata, and relocating and redirecting a remaining part of the payload code that is not randomly relocated.

Here, when randomly relocating the code blocks, the program may perform reading an encrypted metadata file into an enclave and decrypting the same; determining a randomization policy and target code blocks to which the randomization policy is applied; and moving each of the selected code blocks and updating instructions and associated metadata entries for code blocks included in a control flow by referring to the metadata.

Here, when randomly relocating the code blocks, the program may further perform structuring the code blocks and associated inbound/outbound reference metadata entries and loading the same into memory; and generating a data structure for managing information about empty space, which is generated at the original location of the code block by movement of the code block, as an element of runtime metadata.

Here, when determining the randomization policy and the target code blocks, the program may perform selecting code blocks to be moved; determining granularity of the selected code blocks and reflecting the granularity to the metadata; and selecting a location to which each of the code blocks is to be moved among empty space generated by movement of another code block and available page frames in the enclave.

Here, when updating the instructions and the associated metadata entries, the program may perform checking information about empty space generated by movement of a code block and information about space occupied by an operand of a source instruction of an inbound control flow to the target code block to be moved, moving the selected code block to a selected memory location in the enclave, updating a source block instruction of a control flow indicated by an outbound reference of metadata of the moved code block and metadata of a source block and a target block of the control flow, updating a source block instruction of a control flow indicated by an inbound reference of the metadata of the moved code block and metadata of a source block and a target block of the control flow, and updating information about empty space that is partially occupied after being generated by movement of the code block.

Here, when moving the selected code block, the program may add the original memory region of the code block in space information metadata as empty space information, and when the empty space is occupied by a trampoline instruction inserted thereinto due to movement of an additional code block or by an additional code block moved thereto, the program may record the occupied region along with range information thereof.

A method for code randomization in an SGX-based confidential execution region according to an embodiment may include initializing a confidential execution region by executing an SGX enclave shared object file generated and distributed by a publisher apparatus, loading an encrypted payload into memory, and acquiring a decryption key for decrypting the encrypted payload; and decrypting the payload and placing the decrypted payload in the confidential execution region in units of basic blocks with reference to metadata distributed by the publisher apparatus.

Here, placing the decrypted payload may include decrypting payload code in enclave memory, initially placing the payload code in the confidential execution region depending on a file format, randomly relocating a part of code blocks of the initially placed payload code based on the metadata, and relocating and redirecting a remaining part of the payload code that is not randomly relocated.

Here, randomly relocating the code blocks may include reading an encrypted metadata file into an enclave and decrypting the same; determining a randomization policy and target code blocks to which the randomization policy is applied; and moving each of the selected code blocks and updating instructions and associated metadata entries for code blocks included in a control flow by referring to the metadata.

Here, decrypting the encrypted metadata file may include structuring the code blocks and associated inbound/outbound reference metadata entries and loading the same into memory; and generating a data structure for managing information about empty space, which is generated at the original location of the code block by movement of the code block, as an element of runtime metadata.

Here, determining the randomization policy and the target code blocks may include selecting code blocks to be moved; determining granularity of the selected code blocks and reflecting the granularity to the metadata; and selecting a location to which each of the code blocks is to be moved among empty space generated by movement of another code block and available page frames in the enclave.

Here, updating the instructions and the associated metadata entries may include checking information about empty space generated by movement of a code block and information about space occupied by an operand of a source instruction of an inbound control flow to the target code block to be moved, moving the selected code block to a selected memory location in the enclave, updating a source block instruction of a control flow indicated by an outbound reference of metadata of the moved code block and metadata of a source block and a target block of the control flow, updating a source block instruction of a control flow indicated by an inbound reference of the metadata of the moved code block and metadata of a source block and a target block of the control flow, and updating information about empty space that is partially occupied after being generated by movement of the code block.

Here, moving the selected code block may comprise adding the original memory region of the code block in space information metadata as empty space information and recording an occupied region along with range information thereof when the empty space is occupied by a trampoline instruction inserted thereinto due to movement of an additional code block or by an additional code block moved thereto.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram of a system in which a code randomization operation is performed in a confidential execution region based on Intel SGX for a user program and a shared library according to an embodiment;

FIG. 2 is a detailed block diagram for explaining the operation of the publisher of the trusted host in FIG. 1;

FIG. 3 is a detailed block diagram for explaining a code randomization operation in a confidential execution region based on Intel SGX in the cloud node in FIG. 1;

FIG. 4 is a flowchart for explaining a method for random relocation of payload code according to an embodiment;

FIG. 5 is a flowchart for explaining in detail the step of code randomization in units of blocks in FIG. 4;

FIG. 6 is a flowchart for explaining in detail the step of determining a random placement policy and a target code block in FIG. 5;

FIG. 7 is a flowchart for explaining in detail the step of relocating a selected code block and updating an associated instruction in FIG. 5;

FIG. 8 is an exemplary view of insertion of a trampoline instruction according to an embodiment;

FIG. 9 is an exemplary view of processing an outbound ordinary-flow when space is sufficient according to an embodiment;

FIG. 10 is an exemplary view of processing an outbound non-ordinary-flow when space is sufficient according to an embodiment;

FIG. 11 is an exemplary view of processing an outbound non-ordinary-flow when space is insufficient according to an embodiment;

FIG. 12 is an exemplary view of processing an inbound ordinary-flow when space is sufficient according to an embodiment;

FIG. 13 is an exemplary view of processing an inbound ordinary-flow when space is insufficient according to an embodiment;

FIG. 14 is an exemplary view of processing an inbound non-ordinary-flow when space is sufficient according to an embodiment;

FIG. 15 is an exemplary view of processing an inbound non-ordinary-flow when space for a source instruction operand is insufficient according to an embodiment;

FIG. 16 and FIG. 17 are exemplary views of processing an inbound non-ordinary-flow when a preceding trampoline is present and when space for an instruction operand is insufficient according to an embodiment;

FIG. 18 and FIG. 19 are exemplary views of processing of consecutive transfer of adjacent blocks caused due to insufficient space according to an embodiment;

FIG. 20 is an exemplary view of consecutive transfer of two blocks and two branch references by a conditional jump according to an embodiment; and

FIG. 21 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

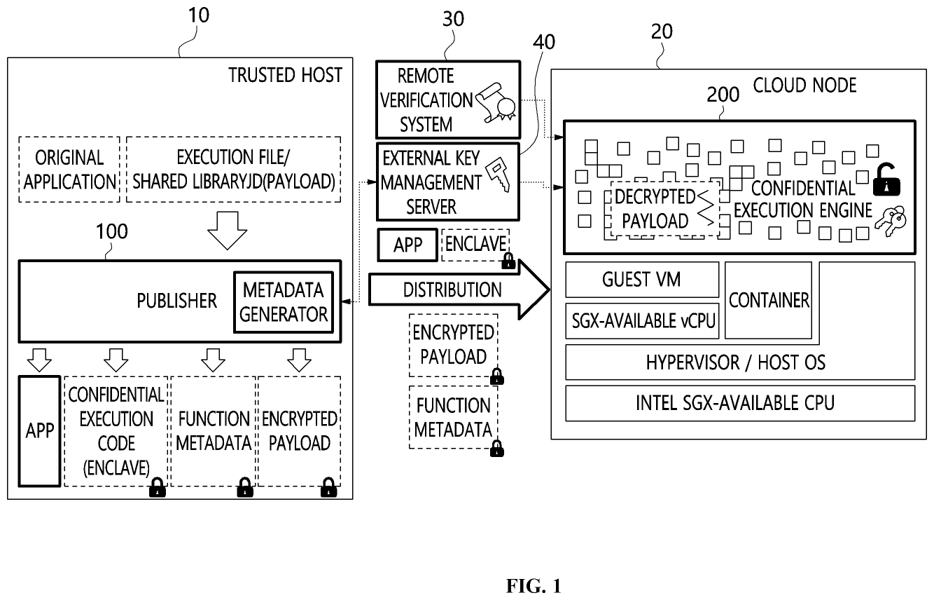

Hereinafter, an apparatus and method for code randomization in a confidential execution region based on Intel SGX for a user program and a shared library according to an embodiment will be described in detail with reference to FIGS. 1 to 21.

FIG. 1 is a block diagram of a system in which a code randomization operation is performed in a confidential execution region based on Intel SGX for a user program and a shared library according to an embodiment.

Referring to FIG. 1, the system to which an embodiment is applied may include a trusted host 10 and a cloud node 20.

The cloud node 20 may be a virtualization environment in which multiple virtual machines are contained and run together on a single hardware device or in which multiple containers are capable of running together. Here, the CPU installed in the cloud node 20 and used for execution of applications may encrypt/decrypt data that is recorded in a memory bus and a system memory region connected therethrough by a memory controller or a CPU module equivalent to the memory controller.

According to an embodiment, the cloud node 20 includes a CPU having an SGX function of Intel, and a hypervisor that supports the use of the SGX function in a virtual machine may be run. However, this may also be applied in a container environment providing the same function, such as a Docker, or the like, or a bare-metal environment.

According to an embodiment, a publisher 100 included in the trusted host 10 generates an SGX enclave shared object file, including a confidential execution engine, and an encrypted payload from a user application (original application) and a payload and extracts payload metadata for payload code randomization.

The SGX enclave shared object file, the encrypted payload, and the encrypted payload metadata may be securely distributed to the target cloud node 20 along with a user application (app).

In the cloud node 20, the distributed SGX enclave shared object file is executed in order to use an SGX function in the SGX enclave. The confidential execution engine 200 included in the SGX enclave shared object file decrypts the distributed encrypted payload and metadata with a decryption key acquired from an external key management server 40 and randomly places some code blocks selected from the payload with reference to the distributed metadata when it loads the decrypted payload into memory. That is, the selected code block is moved to a different page frame such that the same operation is performed at a different memory location.

Accordingly, even though an external observer monitors the control flow of code in the confidential execution region using a page frame access pattern, it is difficult to predict the internal code execution operation because the pattern of access to a page frame is changed each time an enclave is executed according to an embodiment.

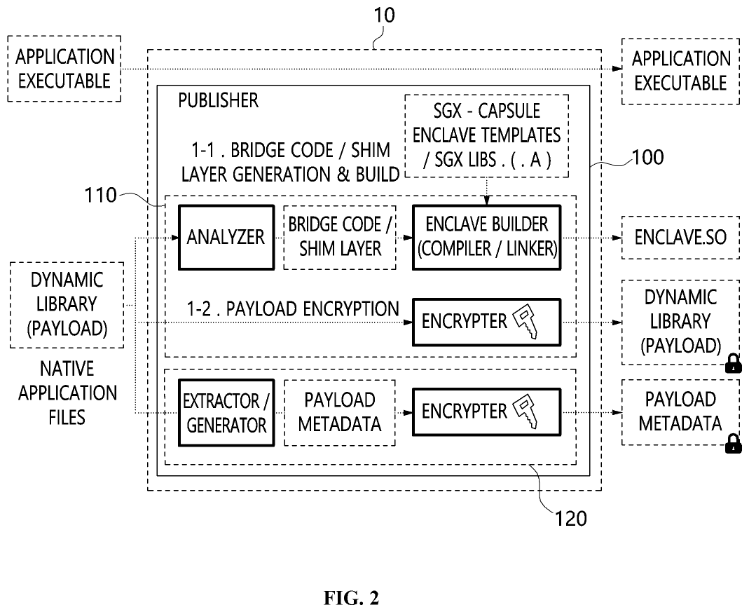

FIG. 2 is a detailed block diagram for explaining the operation of the publisher 100 of the trusted host 10 in FIG. 1.

First, although a payload is illustrated as a shared library in the drawing, a user application (application executable) in a Position-Independent Executable (PIE) format, which can be executed solely, may also be accepted, in which case the user application (application executable) present in an untrusted region only serves to start execution of the entire application and change a control flow to inside the confidential execution region. Hereinafter, unless otherwise indicated, a payload may be assumed to be a shared library.

Referring to FIG. 2, the publisher 100 running in the trusted host 10 may include a confidential execution engine generator 110 and a metadata extractor 120.

The confidential execution engine generator 110 generates a file executable in memory in the encrypted SGX enclave of the cloud node 20 by receiving the path of a user application execution file (application executable) or a shared library file (payload).

First, the confidential execution engine generator 110 generates an SGX enclave shared object file (enclave.so). To this end, the confidential execution engine generator 110 may include an analyzer and an enclave builder, as illustrated in FIG. 2.

The analyzer receives a payload, extracts a list of necessary libraries, and prepares for a connection with the extracted necessary libraries. That is, an interface exposed outside for a call from other code or an interface calling a function of an external library is extracted from the payload. Then, excluding a library running inside the enclave or confidential execution engine template code generated in advance, a shim layer and bridge code passing through an SGX enclave boundary are generated as the interfaces of the remaining libraries.

Accordingly, the enclave builder builds the generated shim layer and bridge code along with the library running inside the enclave, code required for generation of an SGX enclave, and the confidential execution engine template code, thereby generating an SGX enclave shared object file (enclave.so).

Subsequently, the encryptor of the confidential execution engine generator 110 receives the payload and encrypts the same, thereby generating a payload file.

Finally, the confidential execution engine generator 110 may select the user application to distribute depending on the type of the payload.

That is, when the payload is an executable file, a basic execution file for performing a task of loading the SGX enclave shared object file (enclave.so) may be selected as the user application in order to run the confidential execution engine in the cloud node 20.

However, when the payload is a shared library, a user application that loads and uses the shared library may be selected, instead of the basic execution file. Here, because the SGX enclave shared object file (enclave.so) is configured with the same interfaces as the payload, the existing user application, which is run by loading the SGX enclave shared object file (enclave.so) instead of the payload, is not required to be modified.

Meanwhile, the extractor/generator of the metadata extractor 120 parses the unencrypted payload binary file depending on the file format (e.g., ELF64 of Linux), segments instruction sequences of the payload code into basic blocks using a tool such as a disassembler or the like, and extracts metadata on each of the basic blocks.

Here, the metadata on each of the basic blocks may include the range of the basic block, information about the preceding basic block (predecessor), information about the subsequent basic block (successor), the locations of instructions of specified types (call, jmp, mov, and the like) in the basic block, and inbound/outbound control flow reference information.

Here, the range of the basic block may be represented as a pair of byte offsets from the start point of the payload code. Also, the predecessor basic block information and the successor basic block information indicate the relationship with the predecessor and successor basic blocks according to the control flow of the code. Also, the inbound/outbound control flow reference information may include the locations of a source instruction and a target instruction causing the transfer between the basic blocks.

Here, the above-described pieces of information may be recorded in a metadata file in a predefined format.

Also, the encryptor of the metadata extractor 120 encrypts the generated metadata file and outputs the same.

The SGX enclave shared object file (enclave.so), the encrypted payload file, and the encrypted metadata file, generated as described above, may be distributed to the cloud node 20 along with the selected user application.

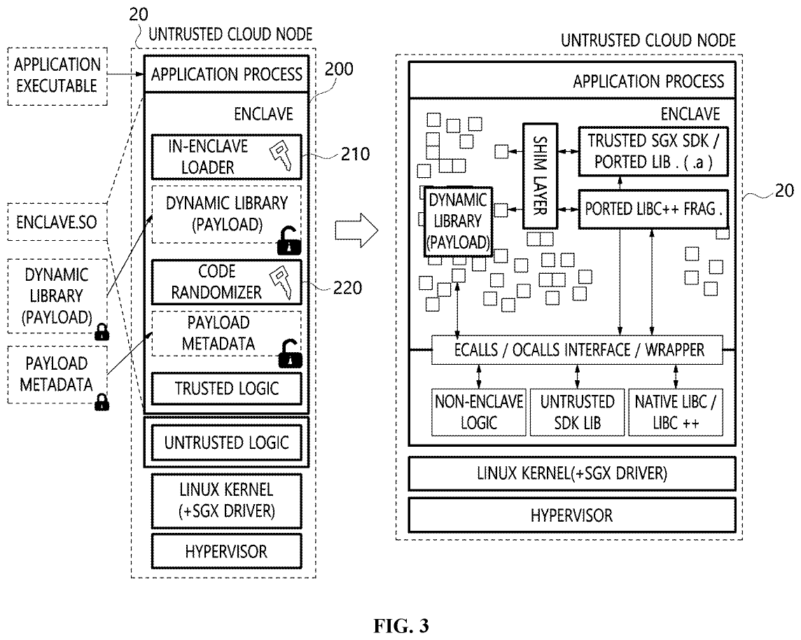

FIG. 3 is a detailed block diagram for explaining a code randomization operation in a confidential execution region based on Intel SGX in the cloud node 20 of FIG. 1.

Referring to FIG. 3, the cloud node 20 executes the payload file distributed by the trusted host 10 in the memory inside the encrypted SGX enclave and uses the metadata file.

First, when the SGX enclave shared object file (enclave.so) is loaded into memory and instantiated at execution time, an enclave 200 is generated. Subsequently, the confidential execution engine included in the SGX enclave shared object file (enclave.so) is executed.

The confidential execution engine may decrypt the distributed encrypted payload file, and may perform fine-grained randomization on some code blocks of the payload so as to be placed at memory locations different from the original memory locations thereof when it loads the decrypted payload into the memory. That is, it moves some code blocks to another page frame such that the same operation is performed at a different memory location.

Here, after the distributed encrypted metadata file is decrypted in the enclave, the target code blocks to be relocated may be selected with reference to the decrypted metadata file.

To this end, the SGX enclave shared object file (enclave.so) may include an in-enclave loader 210 and a payload code randomizer (code randomizer) 220 in addition to trusted logic operating in the encrypted confidential execution region (enclave).

The in-enclave loader 210 decrypts the encrypted payload file, loads the payload file in an executable form into the executable memory region inside a designated enclave depending on the file format (e.g., ELF64 of Linux), and relocates the selected code blocks according to a randomization policy. That is, the in-enclave loader 210 reads the encrypted payload into the enclave, decrypts the same, loads the code of the payload in an executable form by performing relocation and randomization, and performs redirection such that the operation outputs the same result normally.

Here, the redirection process includes the loading process included by default, restoration of a control flow of the randomly placed code, and an operation of redirecting a call of a function that is not present in the payload because it is not loaded into the enclave to a call of a function present in the in-enclave library inside the enclave or a connection operation for linking with an external library or the code of an execution process outside the enclave through bridge code and bringing the execution result in the enclave.

When multiple payloads are present, execution thereof is prepared for by repeating the same task for each of the payloads, in which case it is applied in ascending order of dependency between the payloads. This is performed by providing a substitute library in the enclave or making a connection using a bridge in order to connect the disconnection of the link between the internal code and the external code that results from adoption of the enclave. Accordingly, even though the payload is executed in the enclave, the payload can be executed normally as long as all of the necessary shared libraries can be connected as in a native environment.

In the payload loading process of the in-enclave loader 210, the payload code randomizer 220 nonlinearly relocates one or more payload code blocks in the executable memory in the enclave, regardless of the relative locations thereof that are set depending on the file format of the payload at the loading time. Accordingly, the same execution result may be obtained, and attempts to monitor the page frames in the enclave from the untrusted region outside the enclave and to track the code execution in the enclave at an instruction level based on a memory address access pattern may be reduced.

Specifically, the payload code randomizer 220 determines the code blocks to move and the memory location in the enclave to which the selected code blocks are to be moved based on the payload metadata distributed along with the payload, and moves the code blocks thereto. Then, the control flow that is disconnected by movement of the code blocks is reconstructed so as to be performed normally by reconnecting the same using information about the locations of associated instructions, which is specified in the inbound/outbound metadata entries of the corresponding code blocks.

Here, the modified/added instructions and the reference metadata use the relative location (effective address referred to as ‘EA’ hereinbelow) of an instruction, which is represented using a relative byte address from the start memory address of the payload binary, and include the following.

First, among the instructions included in the relocated code blocks, all of the instructions using the current EA of the instruction or a value changed depending on the byte offset from the current location for the control transfer to an instruction included in a different code block may be included. Here, instructions such as call, jmp, mov, and the like, the target operand of which has to be changed due to the relocation of the code block, may be included in addition to instructions using RIP-relative addressing.

Also, all source instructions included in another code block that cause control transfer to the relocated code blocks may be included.

Also, jmp instructions that are appended to the end of the source code block in order to restore all control flows associated with the relocated code block may be included.

As described above, payload code randomization in the enclave executed on the system illustrated in FIGS. 1 to 3 may be performed through three steps.

At the first step, the publisher 100 running in the trusted host 10 analyzes the payload to be randomly placed using the metadata extractor/generator, thereby extracting metadata and generating a file therefrom.

At the second step, the generated metadata file may be encrypted and securely distributed to the execution target cloud nodes 20 along with other files generated for confidential execution.

At the third step, the payload code randomizer 220 in the generated enclave may read the encrypted metadata file into the enclave, decrypt the same, select the code blocks to be relocated with reference to the decrypted metadata file, move the code blocks, and perform random relocation of fine-grained code for restoration of a control flow. A detailed procedure of each of the steps will be described in detail later.

First, in connection with metadata that is generated in the trusted host 10 at the first step in order to perform random relocation of fine-grained code, concepts related to the used metadata are described as follows.

A code block (or assembly code block) is a unit for payload code randomization, and indicates a set of instructions that are moved together when a specific code segment is relocated by the payload code randomizer 220. The minimum size of such a code block, which is a unit for code randomization, is a single basic block, and each code block that is used may be formed of a single basic block or may be formed by combining one or more pairs of basic blocks having a predecessor-successor relationship.

Here, the size of a code block may be fixed by setting the number of basic blocks constituting the block, set by identifying a code unit by classifying functional/semantic units, such as function units or the like, or set by a user generating the enclave.

That is, because the combined code block may be a set of one or more basic blocks configuring multiple paths inside, such as a reconstructed function and the like, metadata on the combined code block may take one of the following forms.

As a form of the metadata, the metadata may maintain information of each of the basic blocks without change in order to use a method of sequentially moving the basic blocks by regarding the combined code block as a sequence of the basic blocks.

As another form of the metadata, the metadata may be configured in such a way that, when a single code block is moved without a change in the relative location, because information about a control flow between basic blocks in the code block is not required, the inbound/outbound metadata on the basic blocks included in the code block are collected and inbound/outbound information in which both a source and a destination are EAs in the set code block is eliminated from the collected inbound/outbound metadata in order to remove inefficiency.

Also, metadata generated in the publisher regardless of the granularity of a code block is extracted in units of basic blocks, and the payload code randomizer 220 generates code block information for code randomization and uses the same.

Meanwhile, each relative location value used in the metadata is an effective address (EA), which indicates a byte offset of a specific instruction from the start location of the payload binary.

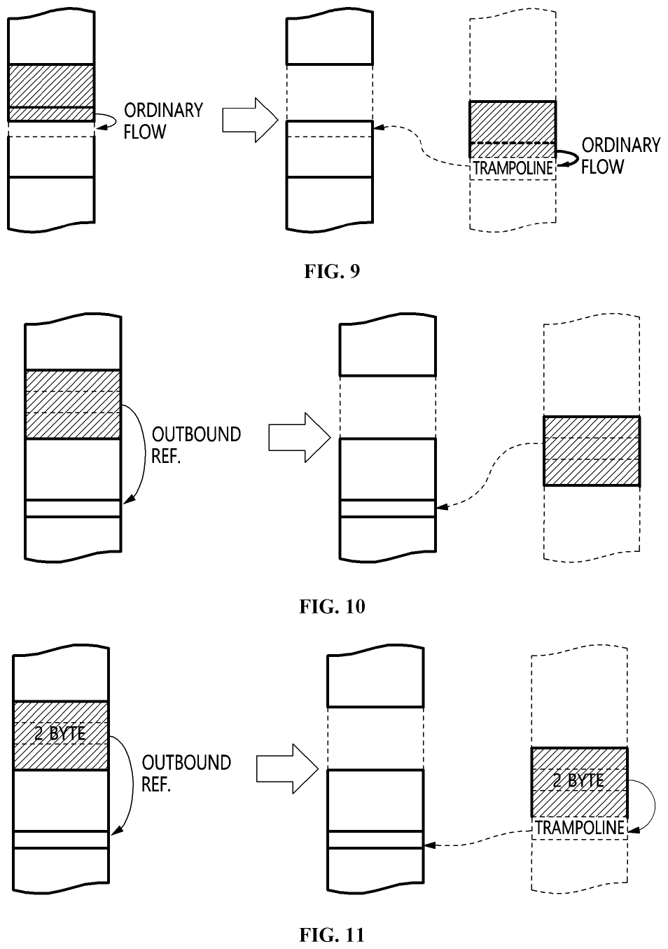

Also, an ‘ordinary flow’ indicates a control flow reference between two basic blocks in which the first instruction of the successor block is executed after execution of the last instruction of the predecessor block according to a characteristic in which successively placed instructions are sequentially executed, as shown in the left drawings in FIGS. 9, 11, 12, 17, and 18 to be described later.

Also, the metadata extractor 120 at the first step segments instruction sequences of unencrypted payload binary code into basic blocks using a tool such as a disassembler or the like and extracts metadata for each of the basic blocks. Here, the extracted payload metadata is a set of entries, each matching a corresponding one of the basic blocks in a one-to-one manner, and each of the entries may be configured as follows.

First, after the payload is separated into basic blocks according to general criteria for segmentation into basic blocks or specially set criteria when necessary, it is segmented into a sequence of assembly code blocks, each being formed of a combination of one or more of the basic blocks, and an instruction sequence of each of the code blocks is written in the form of (start EA, end EA). Here, the instruction located at the last end EA is not included in the corresponding block. The default option is a single code block formed of a single basic block.

Each entry in the metadata for a target basic block contains inbound and outbound metadata entries (a control transfer flow from an instruction in the corresponding basic block to another basic block), and each of the entries represents a possible control flow from the source EA to the target EA.

Here, the inbound control transfer indicates the control transfer flow to the first instruction of the target basic block from an instruction included in another block.

Also, the outbound control transfer indicates the transfer of an execution flow to another basic block by an instruction, such as call, jmp, or mov, in the target basic block or a control flow to another block when it is necessary to execute the first instruction of the next basic block at the following EA by conditional execution of the last instruction of the target basic block (that is, ordinary flow).

The inbound metadata entry includes a list of entries, each comprising the EA of a source instruction included in another predecessor basic block that performs inbound control transfer to the start EA of the corresponding basic block and an ID value for identifying the type of the control transfer. Here, because the target EA of the inbound control transfer is the EA of the instruction at the lowest EA of the corresponding basic block (that is, the first instruction) and is the same as the start EA of the basic block, it is not specially stored.

The outbound metadata entry includes a list of all entries including detailed information about each flow that causes the outbound control transfer from inside the corresponding basic block to another basic block. Here, each of the entries includes the type of the control transfer, the EA of the source instruction causing the control transfer, and the EA values of the target instruction.

Also, an item in which an entry is not present is kept empty.

Also, the type of the inbound/outbound control flow may be classified into an ordinary flow, a near call, a near jump, and data references.

When necessary, the payload code randomizer 220 of the confidential execution engine adds information in the entry.

An example of the configuration of the extracted metadata and a record format may be configured as shown in Table 1 below:

TABLE 1

| Format | Description |
|---|---|
| (A, B) | the start EA and end EA of a basic block, an instruction at |
| | the end EA is not included [start EA, end EA) |
| [(C, D) | the reference type (C) of inbound references that refer to |
| [(E, F)]] | (call/jmp) this block (A, B) and the EA (D) of the source |
| | instruction thereof |
| [(G, H, I) | the reference type (G) of another function code block that |
| [(J, K, L)]] | this block (A, B) refers to (call/jmp) and [start EA(H), end |
| | EA(I)) thereof |

The items in Table 1 are included in an metadata entry for a single basic block, and the EA used therein indicates a byte offset from the start point of the payload binary.

Subsequently, the publisher 100 distributes the files generated for confidential execution including payload code randomization (the SGX enclave shared object file, the metadata file, and the user application executable file) and the payload to one or more target cloud nodes (hosts) at the second step.

Here, the metadata and the payload are encrypted in order to protect the content thereof, and the SGX enclave shared object file is protected by encrypting the same using a Protected Code Loader (PCL) function provided by Intel when necessary. The payload metadata is encrypted as a file separate from the payload and distributed according to need, or may be encrypted along with the payload so as to be distributed as a single file.

At the third step for fine-grained code randomization in the confidential execution region, execution of the payload code randomizer 220 is added to the execution process of the in-enclave loader 210, and the payload code randomizer 220 may perform partial random relocation after initial placement performed by the in-enclave loader 210.

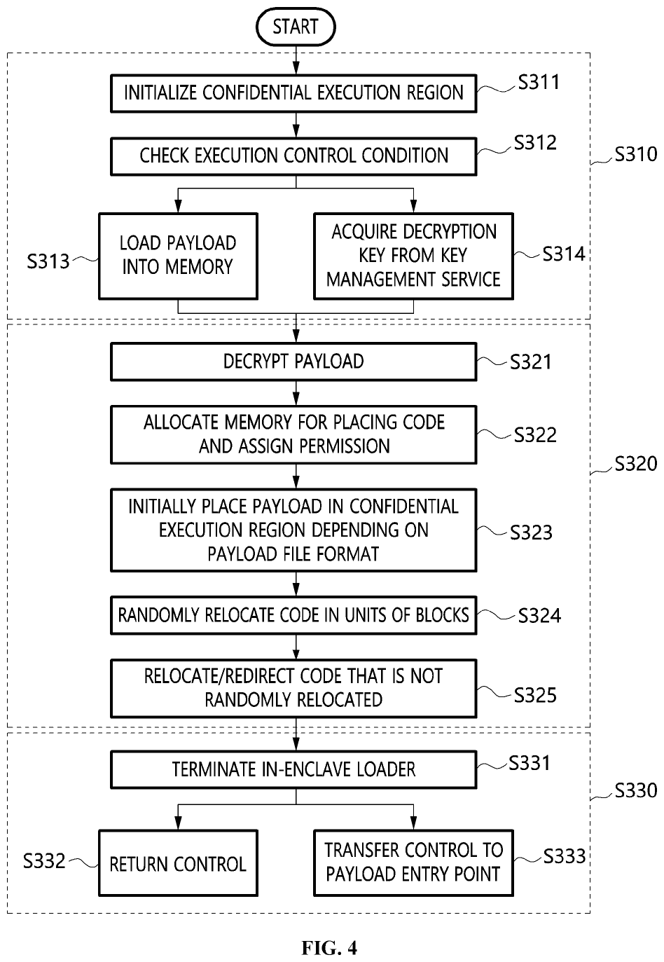

FIG. 4 is a flowchart for explaining a method for randomly relocating payload code according to an embodiment.

Referring to FIG. 4, the overall operation of a confidential execution engine, including fine-grained code randomization after generation of an SGX enclave confidential execution region, is illustrated.

First, the in-enclave loader 210 performs a preparation task for performing fine-grained cod randomization at step S310.

Specifically, the in-enclave loader 210 initializes the SGX enclave confidential execution region at step S311 and checks execution control conditions at step S312. Then, it loads the distributed payload into the enclave memory at step S313 and acquires a decryption key from a key management service at step S314.

Subsequently, the in-enclave loader 210 randomly places the payload code by interworking with the payload code randomizer 220 at step S320.

Specifically, the in-enclave loader 210 decrypts the distributed payload in the enclave memory at step S321.

Subsequently, the in-enclave loader 210 secures a memory region to which write permission is assigned at step S322. Here, when random relocation of the code is completed, execution permission may be assigned to the memory region after the write permission is removed therefrom.

The in-enclave loader 210 initially places the payload code during a relocation task included in the process of loading the payload code depending on the file format of the payload at step S323.

Here, the code segment of the decrypted payload file is copied to the allocated memory based on the ELF file format in order to execute the same in the enclave, and the locations of code segments that are not affected by code randomization are determined and set as the reference points for randomization.

Then, the payload code randomizer 220 randomly relocates (randomizes) basic block code in the memory at step S324.

That is, the number of code blocks to be placed at a memory address different from a prearranged address (initial address) based on the file format, the target code blocks, and the memory location at which the target code block is to be relocated are selected based on entry information for each code block described in the decrypted metadata, and the payload code is randomly relocated in units of blocks at the selected memory locations. Here, the memory in which the code blocks are to be relocated may be allocated, and permission settings may be made. Step S324 will be described in detail later with reference to FIGS. 5 to 7.

Then, the in-enclave loader 210 performs relocation and redirection of the remaining payload code that is not randomly relocated at step S325.

Here, relocation is to change values set to the addresses relative to the start location of the binary to the actual memory addresses in the case of the ELF file, that is, to perform the remaining tasks of relocation, excluding copy of code segments already performed at the initial placement step.

Also, redirection is performed by redirecting a function call of an external library that is not present in the payload to a call of a function present in the static in-enclave library compiled in the enclave in the same manner as redirection of the confidential execution engine or by linking with a shared library outside the enclave boundary or with a function of an external process through bridge code so as to enable the execution result acquired outside the enclave to be imported. Accordingly, even though the already moved code blocks are included in the target of relocation/redirection, the code blocks are modified to maintain the control flow through the random relocation process, so the redirection may be performed regardless of whether random relocation of the code fragments is applied.

When the entire loading process, including relocation of the code segments, is completed, write permission is removed from the memory region in which the execution code segments are located, and execution permission is assigned thereto, whereby Data Execution Prevention (DEP) may be applied.

Finally, when the in-enclave loader 210 is terminated at step S331, the control may be returned to the application process that requested payload initialization through the enclave depending on the type of the payload (an executable file or a shared library) at step S332, or control may be moved to the execution entry point of the payload at step S333.

FIG. 5 is a flowchart for explaining in detail the step (S324) of random relocation of code in units of blocks in FIG. 4.

Referring to FIG. 5, the payload code randomizer 220 performs random relocation of the payload code, which is decrypted and initially placed in the memory inside the enclave, in units of blocks. Here, new values of offsets that are recorded as the operand values of necessary control transfer instructions may be calculated based on an operand value calculation method depending on the type of each instruction.

First, the payload code randomizer 220 reads the encrypted metadata file into the enclave and decrypts the same at step S410.

Subsequently, the payload code randomizer 220 structures metadata entries for each code block and associated inbound/outbound references for retrieval and checking thereof and loads the same into memory at step S420. Here, a data structure, such as a red-black tree or the like, may be used in order to facilitate retrieval.

Also, because the original location of the relocated code block becomes empty, the payload code randomizer 220 generates a data structure for managing information about the empty space as a component of runtime metadata at step S430.

Here, each entry indicating the empty space may be configured with (the start EA of the empty space, the end EA thereof, and the start EA of the subsequent empty space that is not occupied by a trampoline instruction or the like between the start EA and the end EA), similarly to a metadata entry for describing a code block.

Also, the entry indicating the empty space may be generated and added when the transfer of each code block is completed. Here, when the empty space is occupied by addition of a trampoline instruction, or the like, this may be reflected to information of the entry.

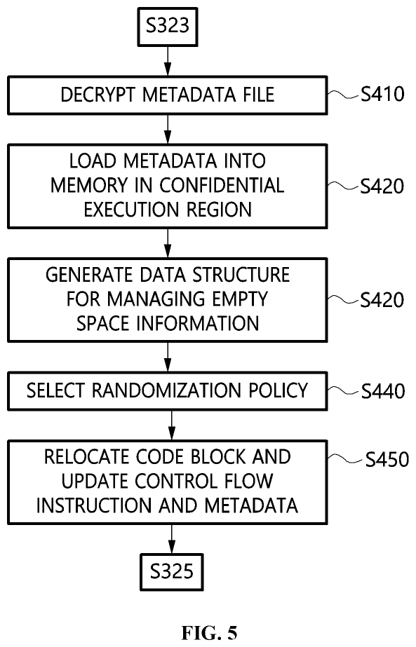

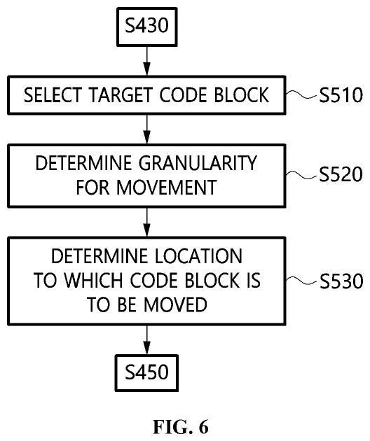

Subsequently, the payload code randomizer 220 selects a randomization policy and a randomization target code blocks at step S440. Here, the code blocks to be moved, the granularity of the selected code blocks, the page frames to which the respective code blocks are to be moved in the enclave, and the locations of the code blocks in the respective page frames may be determined. Step S440 will be described in detail later with reference to FIG. 6.

Subsequently, the payload code randomizer 220 moves all of the selected code blocks. Then, in order to restore a disconnected control flow, the payload code randomizer 220 updates relevant instructions and metadata entries related thereto for the code blocks included in the control flow by referring to the metadata at step S450. Step S450 will be described in detail later with reference to FIG. 7.

FIG. 6 is a flowchart for explaining in detail the step (S440) of selecting a randomization policy and a target code block in FIG. 5.

Referring to FIG. 6, the payload code randomizer 220 selects the target code block to be randomly relocated according to predetermined criteria at step S510.

Here, all of the code blocks capable of being moved, some code blocks, or the target that the publisher 100 receives from a user may be selected.

Here, when the target that the publisher 100 receives from the user is selected, if the input from the user is in the form of an address range (EA range) represented as a pair of EAs, a set of all of the code blocks included in the corresponding memory region is selected. Alternatively, if the input from the user includes the names of one or more specific functions present in the payload, all of the code blocks included in the address region with which the functions are substituted through the preset mapping of the name of the designated function to the EA range may be selected.

Subsequently, the payload code randomizer 220 determines the granularity of the selected code block and reflects the same to metadata at step S520.

Here, each unit block may be individually moved by regarding the same as a single code block. In this case, a change in the metadata, which can be caused by a change in the granularity, may not be required.

Also, when multiple consecutive basic blocks are regarded as a single merged code block and moved together without changing the relative locations between the basic blocks, metadata on all of the unit blocks included in the code block may be merged.

Here, based on the code block region acquired by combining the EA ranges of the basic blocks included therein, metadata entries for inbound/outbound references, of which the source instruction and the target instruction are all included in the block, are excluded, and the remaining metadata is collected and set as the metadata of the combined code block. Operation after that may be the same as operation for general code blocks, each being configured with a single unit block.

Finally, the payload code randomizer 220 selects empty memory space generated by movement of a code block or page frames available in the enclave as the locations to which respective code blocks are to be moved at step S530.

Here, when all of the selected target code blocks to be moved are moved to a single page frame, selecting a page frame for each of the blocks may not be required. Also, placement in the page frame may be performed sequentially, randomly, or using one of methods including a greedy algorithm and the like.

Conversely, the selected target code blocks to be moved are distributed across multiple page frames, the arbitrary code block to be moved is distributed such that code blocks adjacent thereto (that is, predecessor and successor code blocks) are prevented from being placed together with the code block.

Here, the code blocks may be uniformly or non-uniformly placed, and the number of code blocks to be placed in each page frame may be set depending on set criteria.

Here, the criteria for selecting uniform placement or non-uniform placement may include the number of code blocks per page frame, the number of basic blocks, the total number of instructions of unit blocks placed in each page frame, and the total number of branch instructions of blocks placed in each page frame.

Also, the criteria for selecting uniform placement or non-uniform placement may further include the frequency of access to each code block and basic block recorded in metadata if it is present therein, and a certain level of deviation may be allowed depending on the criteria. Here, in order to prevent consecutive code blocks that are not merged from being placed in the same page frame, the page frames to be used are selected in rotation, and placement inside each page frame may be performed based on a selected in-page placement method.

For example, the code blocks may be distributed so as to minimize the difference between the total numbers of instructions placed in the respective target page frames with reference to the number of instructions included in each of the code blocks and the number of added trampoline instructions required at the time of moving the code block.

In another example, when a specific function of a payload is performed in the publisher 100 through advance profiling, the code blocks included in a target control flow may be distributed across page frames such that the total number of times instructions are executed is equal or such that the difference in the numbers of access to the corresponding page frame is minimized.

Also, after the number of code blocks in each page frame is set, a code block is randomly selected so as to avoid the same pattern when selection is repeated, and consecutive blocks, among blocks present in each control flow, are placed in different page frames. Here, among the blocks included in the same control flow as the selected block, the block to be placed in a different page frame based on the minimum value of the difference in the EAs of the blocks is selected as the block to be placed in the same page frame. Here, the number of multiple page frames to be used in order to respond to the control flows having an equal number of blocks is randomly selected.

Also, when the page frames are selected in rotation, selection may be performed such that a difference in the addresses of the page frames used together is not uniform.

Meanwhile, criteria for selecting a target code block at step S510 in FIG. 6 will be described in detail below.

First, when the code blocks to be moved are autonomously selected without input from outside, one of the following methods may be selected and performed depending on information provided along with the number of new page frames to which the code blocks are to be placed and the metadata.

That is, the publisher 100 may collect statistical information about a control flow in the enclave and add the same in the metadata of each code block as an additional element. Here, the additional element of the metadata may include information that can be acquired by advance profiling so as to enable the location of the code to be estimated by combining control flow information, such as priority of the block, the access frequency thereof, and the locality information thereof, and an identifier indicating that the block is specified by the publisher so as to be definitely moved.

Also, when profile information for execution is included, the degree of identifying each block is calculated based thereon. For example, the access frequency of each block may be used as the identifiable value of the code block without change. Alternatively, when a priority value is also added, the profile information may be used as the identifiable value by using the priority value as a weight. When the publisher sets a block as the block that is definitely required to be moved, high priority is assigned thereto, whereby the block is separated from adjacent blocks by moving the block to a page frame different from the page frame to which the adjacent blocks are moved.

Also, items that are marked with importance or marked as being required to be moved are selected in order of importance and placed in different page frames. When blocks have the same importance, a block may be randomly selected.

FIG. 7 is a flowchart for explaining in detail the step (S450) of changing the location of a selected code block and updating an associated instruction in FIG. 5.

Referring to FIG. 7, the payload code randomizer 220 checks information about empty space and information about the space occupied by the operand of the source instruction of an inbound control flow to the target code block to be moved at step S610.

That is, the payload code randomizer 220 checks whether the operand of the source instruction of the inbound/outbound references associated with the moved code block has space that can contain the offset value changed by the new location of the moved code block.

Here, the checked information about the space may be used as the criteria for updating the instruction and metadata for each of the case in which the space is sufficient and the case in which the space is insufficient. Here, space management is not required when a method of sequentially appending code in the newly allocated space is used.

Subsequently, the payload code randomizer 220 moves the selected code block to the selected memory location in the enclave at step S620.

Here, the original memory region in which the code block was placed is initialized with zeros, and information about the empty space generated by moving the code block may be added in space information metadata. Here, the added space information may be configured with (the start EA, the end EA, and the start EA of the unoccupied space), and a method of describing the start EA and the end EA may be the same as the method used for a block.

Subsequently, when the corresponding empty space is occupied by a trampoline instruction inserted thereinto due to movement of another code block or by another code block moved thereto, the occupied region is recorded along with the range information thereof such that whether the space is occupied can be checked when the location at which a trampoline instruction is to be inserted is determined.

Basically, the corresponding space is sequentially occupied from the start location thereof. However, when necessary, the middle of the space may be used, in which case information about the corresponding space is managed by separating the space based on the start location of the occupied space.

Subsequently, the payload code randomizer 220 refers to an outbound reference in the metadata on the moved block and updates an instruction in the source block of the control flow indicated by the outbound reference and metadata on the source/target blocks of the corresponding control flow at step S630.

Here, various embodiments may be possible depending on the type of each outbound reference of the moved block and the space information.

First, according to an embodiment, when the reference type is an ordinary flow type, this is first reflected, and when it is necessary to insert a trampoline instruction, the trampoline instruction may be placed at the location of the next instruction of the source instruction of the ordinary flow reference, rather than being placed after another trampoline instruction. The definition of such an ordinary flow and detailed operation related thereto will be described later with reference to FIGS. 10, 18 and 19.

According to another embodiment, the case in which the reference type is not an ordinary flow type will be described later with reference to FIG. 10 and FIG. 11.

Subsequently, the payload code randomizer 220 refers to metadata on an inbound reference for an inbound control flow to the moved block and updates the source instruction of the source block of the control flow indicated by the reference, metadata on the source block, and the metadata on the target block (moved block) at step S640.

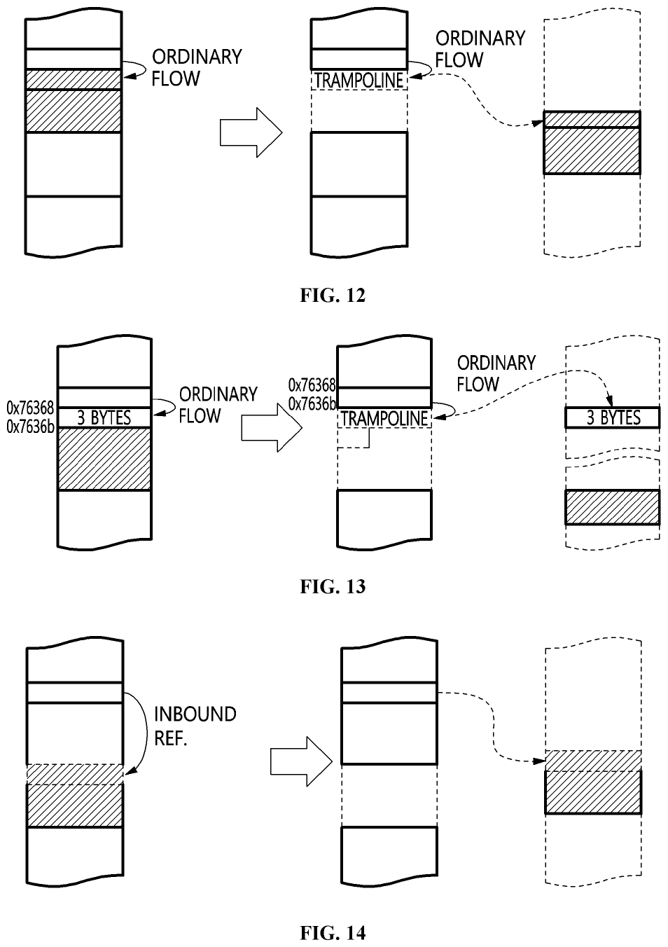

Here, depending on the type of the inbound reference and the space information, the reference metadata and the instruction for the reference of an ordinary flow type may be performed as shown in FIG. 12 and FIG. 13.

Meanwhile, the update of an instruction and metadata for each inbound reference that is not an ordinary flow may be performed as shown in FIGS. 14, 15, 16 and 17.

When a trampoline instruction is added in the process of updating a control flow and when the reference type is an ordinary flow type, the corresponding instruction is added to the end of the source block (previous block), whereby the block is expanded.

Meanwhile, when the flow is not an ordinary flow, a code block in which the added trampoline instruction itself is set as an independent basic block is generated, and a metadata entry related thereto is immediately generated and added.

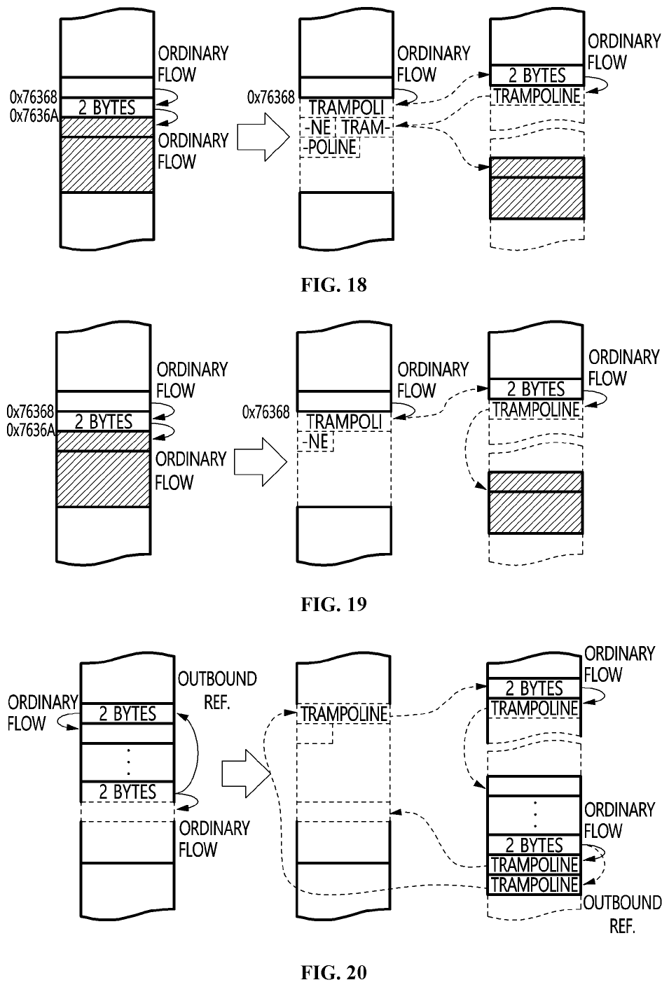

Complex situations other than that is performed as shown in FIGS. 18, 19, and 20.

Subsequently, the payload code randomizer 220 updates information about the empty space that is partially occupied after being generated by movement of a code block at step S650.

FIGS. 9, 10, and 11 illustrate a process of updating an instruction and details of metadata related to an outbound reference of a code block that is relocated by the payload code randomizer 220.

Here, space that is used indicates an instruction operand memory region in which an offset value can be stored or an empty memory region into which an instruction can be inserted. Sufficient space means that space (5 bytes) for storing a trampoline instruction or the size of memory (4 bytes) for containing the operand of a source instruction can be secured depending on the circumstances.

Here, an ordinary flow indicates that the first instruction of a successor block executed after execution of the last instruction of an arbitrary code block (a predecessor block) is located immediately after the instruction executed just before in the memory. For example, after a 4-byte instruction located at the memory address of 0x1230 is executed, if a control flow reference of an ordinary flow type is present, the location of the instruction to be subsequently executed indicated by the control transfer is 0x1234. This occurs when the control transfer between blocks is caused by sequential execution of the next instruction after a conditional branch instruction, the condition of which is not satisfied, is executed, rather than by the control transfer by call, jmp, mov, or the like. Accordingly, modifying the operand of the source instruction of the control flow is inadequate to reflect a control flow that is changed by movement of a code block.

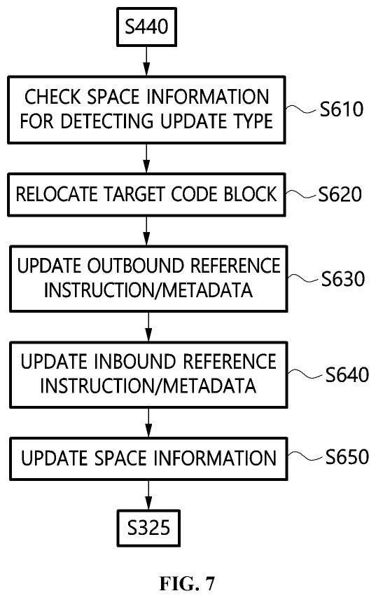

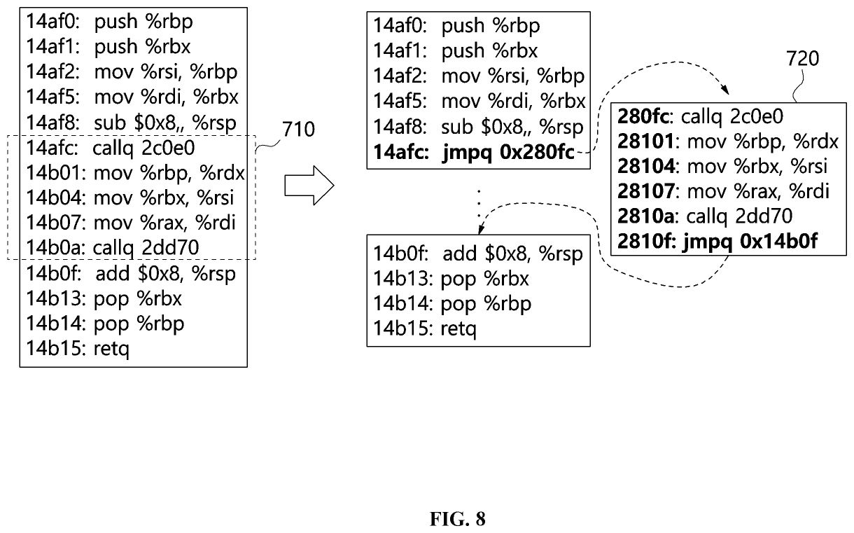

In an embodiment, a jmp instruction (trampoline instruction) is added to the end of the source block of the control transfer (the predecessor block in this case) as illustrated in FIG. 8. Then, this jmp instruction is regarded as a changed source instruction, and the offset value of the trampoline instruction is set, whereby the above-mentioned problem is solved.

FIG. 9 illustrates the situations before and after update when memory space for adding a trampoline instruction is sufficient in the state in which it is necessary to perform the process of updating reference metadata and an instruction in order to restore an outbound ordinary-flow reference starting from a moved block.

When the block marked with diagonal lines is moved to another memory location, the payload code randomizer 220 performs the following operation in order to update metadata.

First, after the outbound target block is searched for, an inbound reference, the source of which is set to the moved block, is retrieved from the inbound reference list of the outbound target block, and the source EA of the corresponding metadata is updated to the EA value of the added trampoline instruction.

Then, the source EA of the outbound reference of the moved block is updated to the EA value of the added instruction.

Also, metadata is updated such that the range of the moved block includes the trampoline instruction.

In order to update the related instructions, the payload code randomizer 220 adds a trampoline jmp instruction at the end of the block and sets an offset such that the target of the instruction is set to the target EA (the start EA of the next block) of the original outbound reference, as pointed to by the dotted arrow in FIG. 9.

This makes the trampoline instruction to be executed without changing the original source instruction, because the type of the control flow reference, which is the current update target, is an ordinary flow, that is, the case in which the last instruction of the block is executed and then the instruction located at the next byte is executed.

Because the part at the next memory address of the moved block is always empty space by the current block movement policy, there is no need to specially manage the space, but when necessary, whether the space is occupied is checked based on space management information as in the inbound reference processing, whereby the space in which an additional instruction is to be placed is set and secured.

The outbound ordinary-flow when the space is not sufficient will be described later with reference to FIG. 18 and FIG. 19.

FIG. 10 illustrates a process of processing an outbound control flow that is not an ordinary flow when the size of space containing the operand of the source instruction of the outbound control flow is sufficient to store a changed offset value.

In order to update the source instruction of an outbound reference, the operand of the source instruction of the outbound control flow included in the moved block is modified to have an offset value to which the new location is reflected, as illustrated in the drawing.

In order to update metadata, when inbound metadata based on the moved block, which is about an inbound control flow from the outbound target block of the moved block to the moved block, is present, the source EA value of the corresponding inbound reference is modified to the changed EA of the source instruction depending on the changed block location.

Also, the source EA of the outbound reference metadata of the moved block may be modified to the changed EA of the source instruction depending on the changed block location.

FIG. 11 illustrates a process of processing an outbound control flow that is not an ordinary flow when the size of space containing the operand of the source instruction of an outbound control flow is not sufficient to store a changed offset value.

As illustrated in FIG. 11, when the operand of the source instruction (2 bytes) of an outbound control flow included in the moved block cannot store the offset value to which the new location is reflected as illustrated in the drawing (e.g., a short jump instruction having a 1-byte operand space cannot store a 4-byte offset value), instruction update may be performed by adding a trampoline jmp instruction to the end of the moved block. Here, when a trampoline instruction is already added by a different reference, such as an ordinary flow or the like, the trampoline jmp instruction may be added at the location of the next empty byte.

Then, for the corresponding reference, the target of the source instruction in the moved block is changed to the added trampoline jmp instruction (the solid arrow), that is, the reference from the source instruction is changed to the control transfer inside the block, which is not recorded in the metadata, and the source of the outbound reference is changed to the added jmp instruction.

Also, in order to update metadata, when inbound reference metadata about an inbound control flow from the moved block to the outbound target of the moved block is present, the source EA value of the inbound reference is changed to the EA of the trampoline jmp instruction added to the end of the moved block.

Then, the source EA of the outbound reference metadata of the moved block, which is marked with the solid arrow, is changed to the EA of the trampoline jmp instruction added to the end of the moved block.

The range of the moved block is expanded to include the added trampoline instruction.

FIG. 12 illustrates a process of processing an inbound ordinary-flow to a moved block when remaining space in the empty memory space generated by movement of the block is able to contain a trampoline instruction.

In order to update metadata, an outbound reference, the target of which is the old start EA of the moved block, among the outbound references of the source block of an inbound reference (that is, the outbound references of a predecessor block), is searched for, and the target EA value thereof is updated to the EA of the changed location. Here, because a jmp instruction is added to the source block of the inbound reference for a trampoline in the instruction update process, the source of the inbound reference of the ordinary flow based on the moved block is set to the newly added trampoline instruction. Because the trampoline instruction is added to the end of the block, the ordinary flow is changed to the control transfer inside the block, so this is not recorded in the metadata. Instead, the EA of the trampoline instruction is recorded as the EA of the source instruction of the reference, and the type of the reference is modified to a non-ordinary flow (the dotted arrow). The target instruction of the reference is changed to the EA value of the changed location.

The range of the source block is expanded to include the added trampoline instruction, and information about occupancy of the empty space, which is maintained for managing the empty space generated by movement of the code block, is also updated.

The inbound metadata entry of the moved code block is updated. This process is the same as the update of the metadata of the source block of the inbound reference.

In order to update the instruction, a trampoline jmp instruction is added to the end of the source code block of the inbound reference and the source block is expanded, as shown in FIG. 12, because the type of the inbound reference is an ordinary flow. Then, the offset value is recorded such that the added trampoline jmp instruction transfers the control to the start EA of the moved code block, whereby the target is set.

Here, because the source block of the ordinary flow is the predecessor block, empty space, the size of which is equal to the size of the moved block, is generated in the memory region after the source block. The added jmp instruction is placed in this space.

Also, a maximum of one ordinary flow reference is allowed in each basic block according to the definition. When such an ordinary flow reference is present, the ordinary flow reference is processed earlier than any other types of references, and when a trampoline instruction is required, the original source instruction is not modified, and the trampoline instruction is made to be executed at the location of the next byte of the source instruction.

FIG. 13 illustrates a process of processing an inbound ordinary-flow of a moved block when the remaining space in the empty memory space generated by movement of an arbitrary block cannot contain a trampoline instruction.

In order to secure space for containing a trampoline instruction, the next block is moved, whereby the required space is secured. Also, metadata is changed for the reference information and information about the empty space generated by movement of the block.

The process of updating the metadata is the same as the processing method that is used when the space is sufficient, as in FIG. 12, but the next block is consecutively moved until sufficient space is secured, and the space is secured by updating the empty space information and the metadata on the moved blocks. In order to determine whether the remaining space is sufficient, a value acquired by excluding the occupant part from the empty space range is used.

Because the reference type is an ordinary flow, when the empty space is sufficient, the source code block of the inbound reference has to be expanded by adding a trampoline jmp instruction to the end of the source code block as shown in FIG. 12 in order to update the instruction. However, in the situation shown in FIG. 13, the size of the moved block is 3 bytes, so the empty space generated by the movement of the block cannot contain a 4-byte trampoline instruction, unlike that shown in FIG. 12.

In this case, the next block (marked with diagonal lines) is also moved, as shown in FIG. 13. Here, in order to secure the space first, the code bytes of the next block are moved to temporary storage space, after which a trampoline instruction is added first for the moved block. Then, the target block to be moved next is set to the temporarily stored block, whereby the block is moved. When the space is insufficient despite the movement of the consecutive blocks, this process is repeated until the sufficient space is secured.

In the case of the ordinary flow, a maximum of one ordinary flow is allowed in each basic block according to the definition. When such an ordinary flow is present, it is processed earlier than any other types of references, and when a trampoline instruction is required, the source instruction is not modified, and the added trampoline instruction is made to be executed at the location of the next byte of the source instruction.

FIG. 14 illustrates a process of processing an inbound non-ordinary flow when the operand of a source instruction of a source block of an inbound control flow to a moved block has byte space sufficient to contain a changed offset value in response to movement of the block.

Because the operand of the source instruction of the inbound reference has byte space that can contain the changed offset to the moved block, the corresponding operand value is updated in order to update the instruction.

Metadata is also updated by searching for an entry that records the outbound reference of the source block of the inbound reference and modifying the target value of the outbound reference to the changed start EA of the moved block.

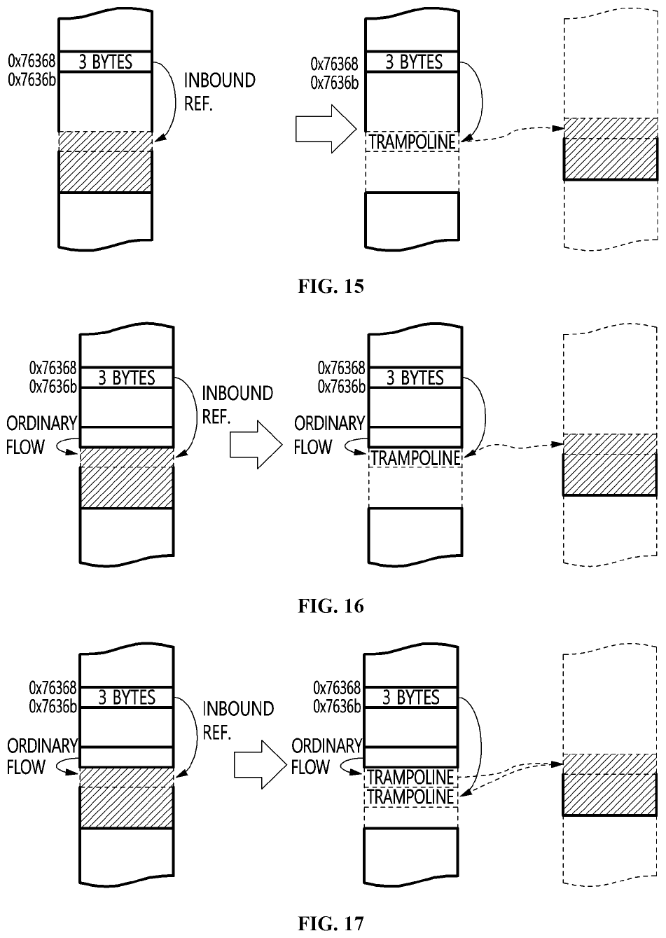

FIG. 15 illustrates a process of processing an inbound non-ordinary flow when the operand space of the source instruction is not sufficient to contain the changed offset value in the same situation as the case in FIG. 14. In the example of the drawing, the size of the source instruction is 3 bytes, and cannot store the offset value to the changed location, which occupies 4-byte operand space.

Because empty space is generated by moving the target code block of the inbound reference, after sufficient space is secured at the corresponding location, as shown in FIG. 15 and FIG. 16, a jmp instruction is added therein as a trampoline such that the control flow is transferred to the start EA of the moved code block in order to update the instruction.

In this method, because the relative location of the target instruction is limited by the size of the value that can be contained by the operand of the original source instruction due to the limited byte space of the operand, a trampoline instruction is put in the empty space in the region that can be pointed to by the original source instruction, and execution is performed via this instruction, whereby control is transferred to the moved block.

Here, because an instruction for processing another reference may be inserted into the empty space generated by movement of the code block, whether the empty space is occupied is managed using separate runtime metadata. When the size of the actual empty space calculated based on this information is determined to be sufficient, a trampoline instruction is placed in the empty space, as shown in FIG. 16 or FIG. 17. Here, when two identical trampolines for jumping to the same location are present, as shown in FIG. 17, implementation by which the two trampolines are merged into a single trampoline instruction as shown in FIG. 16 may be selected.

When the size of the unoccupied empty space is not sufficient, space is secured by consecutively moving adjacent blocks, as shown in FIG. 18 and FIG. 19.

The operand of the original source instruction is updated, whereby the added trampoline jmp instruction is set as the target. This is required in preparation for the case in which multiple trampoline instructions are placed in the empty space.

Because the trampoline instruction is not intended to be executed by an ordinary flow from a predecessor block based on the location at which the trampoline instruction is placed, it is not appended to the predecessor block but is regarded as an independent code block, and a new metadata entry is generated therefor at runtime in order to update the metadata.

The generated metadata includes information about the range of the code block configured with the single instruction, the inbound reference from the original source instruction, and the outbound reference to the moved code block. Here, the source instruction EA of the inbound reference of the newly generated block uses the EA of the original source instruction, and the target EA thereof uses the EA of the trampoline instruction. The source of the outbound reference is set to the EA of the corresponding trampoline instruction, and the target EA is set to the start EA of the moved block.

The outbound reference of the block in which the original source instruction is included is updated to the EA of the corresponding trampoline instruction, and the EA of the source instruction of the inbound reference of the moved block is updated to the EA of the trampoline instruction.

FIGS. 18, 19, and 20 illustrate two examples that are compositely configured in connection with the detailed operation of the payload code randomizer 220.

The size of a code block may vary depending on a tool for extracting metadata and a user, and a single instruction that branches into an ordinary flow and an outbound reference depending on an execution condition may be present.

FIG. 18 illustrates the first example. When a block including both the inbound ordinary-flow and the outbound ordinary-flow of an instruction in which space occupied by the operand thereof is not sufficient is moved, a trampoline instruction is added for each of the ordinary flows, as described above, and space for containing the trampolines is secured, whereby the changed control flow is set so as to generate the same result. In FIG. 18, the space is secured by also moving an adjacent block, and the control flow is restored by inserting the consecutive trampoline instructions.

In the example of FIG. 19, when control jumps from the trampoline instruction to another trampoline instruction in the result of FIG. 18, the trampoline instructions are merged, whereby the efficiency is improved. As in the above example, a trampoline instruction for an ordinary flow is processed to be included in the predecessor block, but trampoline instructions added after that are processed by being regarded as individual blocks.

The second example illustrates movement of a block including ordinary flows and an outbound reference in the form of a loop, as shown in FIG. 20. In this case, a trampoline instruction is inserted for the ordinary flow related to the moved block, as described above, and when the size of the space occupied by the operand is small, space is secured in nearby empty memory space, and the trampoline instruction is put therein, whereby a control flow is connected.

When the task by the payload code randomizer 220 is completed, the in-enclave loader 210 performs relocation and redirection tasks on the entire payload code as shown in FIG. 4, thereby completing the loading task. Here, metadata that is not used any longer is deleted from the memory.

In connection with the operation of the in-enclave loader 210 and the payload code randomizer 220 in the enclave, the permission assigned to the page frame in which the code of a payload is located should be in the form of exclusive OR (XOR) of write permission and execution permission. The present disclosure assumes the case in which a CPU supporting Intel SGX version 2 executes the in-enclave loader 210 and the payload code randomizer 220 and protects the enclave using a dynamic memory management (DMM) function by assigning only write permission to the enclave memory when code is placed therein and by assigning only execution permission to the enclave memory after removing the write permission therefrom when the code is executed after the placement is completed. When a CPU supporting only SGX version 1 that does not have a DMM function is used, a method such as Data Execution Prevention (DEP) implemented in software, which is proposed in SGX-Shield (J. Seo et al., ‘SGX-Shield: Enabling Address Space Layout Randomization for SGX Programs,’ NDSS 2017), may be used, but it is not dealt with in the present disclosure.

Depending on the implementation method, the payload code randomizer 220 is distributed by being included in the SGX enclave shared object file, like the in-enclave loader 210, or may be distributed in the form of a separate encrypted executable file along with the payload by being implemented as a code segment in the form of a function or as an API included in a shared library so as to be called. When it is included in the SGX enclave shared object file, the payload code randomizer 220 may be executed through the same process as in the method described herein, but when it is distributed in the form of a separate encrypted binary file, the in-enclave loader 210 decrypts the payload and the file containing the code of the code randomizer, places the same in the memory in the enclave, randomly relocates the code in an executable form, and connects the code to its code calling the code randomizer.

Here, because the payload code randomizer 220 is executed and then removed before the payload is executed, a code randomization function is not performed therefor. Subsequently, the in-enclave loader 210 performs loading and code randomization for the decrypted payload in the same manner as the above-described method.

Also, the process in FIG. 4 is illustrated as being performed in the order in which the payload code randomizer 220 performs code randomization on the payload first and the in-enclave loader 210 performs relocation and redirection in order to reduce execution load of runtime, but the order may be changed by changing metadata depending on the implementation method. When relocation and redirection are performed before code randomization, the metadata that is used has to be updated so as to have an offset to which the difference in the relative memory address between respective instructions after the relocation and redirection in the loading process is reflected, rather than an EA using the relative offset difference between the respective instructions extracted from the payload binary.

Here, with regard to the change of the metadata, various embodiments may be possible depending on the location at which a changed value is acquired.

According to an embodiment, an EA value that is acquired in such a way that the metadata extractor 120 simulates the relocation and redirection process that the in-enclave loader 210 performs depending on the file format of a corresponding payload may be applied to metadata, and then the metadata may be distributed.

According to another embodiment, the payload code randomizer 220 receives the distributed metadata in the existing format, and after relocation and redirection are completed, the changed location values applied at the time of relocating and redirecting respective code blocks and EAs including offsets recorded in the metadata are stored and modified to match the changed location of the payload code, and the code randomization process may be applied in the same manner.

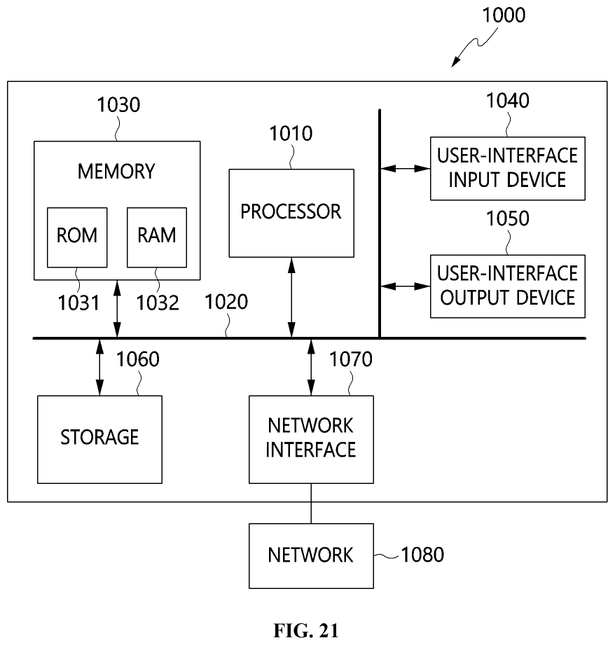

FIG. 21 is a view illustrating a computer system configuration according to an embodiment.

The trusted host 10 and the cloud node 20 according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, repeated attempts to steal information by external controlled-channel attacks are reduced in such a way that a user partitions, randomly places, and executes the code of a confidential execution target application or shared library in encrypted memory using the SGX function of an Intel CPU without modifying the target binary, whereby high confidentiality of code execution context and data may be provided.

Also, according to the disclosed embodiment, because a target program is capable of being run on an untrusted OS running in a virtual machine of a cloud node, a container instance, or a bare-metal environment using a CPU and a mainboard supporting SGX technology without modifying or recompiling the code of the target program, information desired by a user or code execution may be protected in various environments.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A publisher apparatus, comprising:
memory in which at least one program is recorded; and
a processor for executing the program,
wherein:
the program includes a confidential execution engine generator for receiving a user application execution file or a payload file and generating a Software Guard eXtensions (SGX) enclave shared object file to be executed in an encrypted SGX enclave, an encrypted payload file, and a user application execution file; and a metadata extractor for analyzing the payload file, segmenting instruction sequences included in a payload into basic blocks, and generating metadata on each of the basic blocks, and
the SGX enclave shared object file, the encrypted payload file, the user application execution file, and the metadata are distributed to a cloud node capable of executing at least one SGX enclave.

2. The publisher apparatus of claim 1, wherein the confidential execution engine generator generates a shim layer and bridge code that pass through a boundary of the SGX enclave based on an interface for calling external library code other than the payload and an interface exposed from the payload in order to respond to a call from other external code, and builds the shim layer and the bridge code along with a library in the SGX enclave and confidential execution template code, thereby generating the SGX enclave shared object file.

3. The publisher apparatus of claim 1, wherein the SGX enclave shared object file includes:
an in-enclave loader for decrypting an encrypted payload, loading the decrypted payload into an executable memory region in a specified SGX enclave depending on a file format so as to be executable, and relocating a selected payload code block according to a randomization policy; and
a payload code randomizer for selecting a code block to be moved based on distributed payload metadata, determining a memory location in the enclave to which the selected code block is to be moved, moving the selected code block thereto, and restoring a control flow disconnected by movement of the code block by reconnecting the control flow using instruction location information specified in inbound/outbound metadata entries of corresponding code blocks.

4. The publisher apparatus of claim 1, wherein the metadata on each of the basic blocks includes a range of the basic block represented as a pair of byte offsets from a start point of payload code, a relationship with a predecessor basic block or a successor basic block according to a control flow of the code, locations of instructions of a designated type in the basic block, and inbound/outbound control flow reference information including locations of a source instruction and a target instruction that cause movement between the basic blocks.

5. An apparatus for code randomization in a Software Guard extensions (SGX)-based confidential execution region, comprising:
memory in which at least one program is recorded; and
a processor for executing the program,
wherein the program performs
initializing a confidential execution region by executing an SGX enclave shared object file generated and distributed by a publisher apparatus, loading an encrypted payload into memory, and acquiring a decryption key for decrypting the encrypted payload; and
decrypting the payload and placing the decrypted payload in the confidential execution region in units of basic blocks with reference to metadata distributed by the publisher apparatus.

6. The apparatus of claim 5, wherein, when placing the decrypted payload, the program performs
decrypting payload code in enclave memory;
initially placing the payload code in the confidential execution region depending on a file format;
randomly relocating a part of code blocks of the initially placed payload code based on the metadata; and
relocating and redirecting a remaining part of the payload code that is not randomly relocated.

7. The apparatus of claim 6, wherein, when randomly relocating the code blocks, the program performs
reading an encrypted metadata file into an enclave and decrypting the encrypted metadata file;
determining a randomization policy and target code blocks to which the randomization policy is applied; and
moving each of the selected code blocks and updating instructions and associated metadata entries for code blocks included in a control flow by referring to the metadata.

8. The apparatus of claim 7, wherein, when randomly relocating the code blocks, the program further performs
structuring the code blocks and associated inbound/outbound reference metadata entries and loading the code blocks and the associated inbound/outbound reference metadata entries into memory; and
generating a data structure for managing information about empty space, which is generated at an original location of the code block by movement of the code block, as an element of runtime metadata.

9. The apparatus of claim 7, wherein, when determining the randomization policy and the target code blocks, the program performs
selecting code blocks to be moved;
determining granularity of the selected code blocks and reflecting the granularity to the metadata; and
selecting a location to which each of the code blocks is to be moved among empty space generated by movement of another code block and available page frames in the enclave.

10. The apparatus of claim 7, wherein, when updating the instructions and the associated metadata entries, the program performs
checking information about empty space generated by movement of a code block and information about space occupied by an operand of a source instruction of an inbound control flow to the target code block to be moved;
moving the selected code block to a selected memory location in the enclave;
updating a source block instruction of a control flow indicated by an outbound reference of metadata of the moved code block and metadata of a source block and a target block of the control flow;
updating a source block instruction of a control flow indicated by an inbound reference of the metadata of the moved code block and metadata of a source block and a target block of the control flow; and
updating information about empty space that is partially occupied after being generated by movement of the code block.

11. The apparatus of claim 10, wherein, when moving the selected code block, the program adds an original memory region of the code block in space information metadata as empty space information, and when the empty space is occupied by a trampoline instruction inserted due to movement of an additional code block or by an additional code block moved thereto, the program records the occupied region along with range information thereof.

12. A method for code randomization in a Software Guard extensions (SGX)-based confidential execution region, comprising:
initializing a confidential execution region by executing an SGX enclave shared object file generated and distributed by a publisher apparatus, loading an encrypted payload into memory, and acquiring a decryption key for decrypting the encrypted payload; and
decrypting the payload and placing the decrypted payload in the confidential execution region in units of basic blocks with reference to metadata distributed by the publisher apparatus.

13. The method of claim 12, wherein placing the decrypted payload includes decrypting payload code in enclave memory;
initially placing the payload code in the confidential execution region depending on a file format;
randomly relocating a part of code blocks of the initially placed payload code based on the metadata; and
relocating and redirecting a remaining part of the payload code that is not randomly relocated.

14. The method of claim 13, wherein randomly relocating the code blocks includes
reading an encrypted metadata file into an enclave and decrypting the encrypted metadata file;
determining a randomization policy and target code blocks to which the randomization policy is applied; and
moving each of the selected code blocks and updating instructions and associated metadata entries for code blocks included in a control flow by referring to the metadata.

15. The method of claim 14, wherein decrypting the encrypted metadata file includes
structuring the code blocks and associated inbound/outbound reference metadata entries and loading the code blocks and the associated inbound/outbound reference metadata entries into memory; and
generating a data structure for managing information about empty space, which is generated at an original location of the code block by movement of the code block, as an element of runtime metadata.

16. The method of claim 14, wherein determining the randomization policy and the target code blocks includes
selecting code blocks to be moved;
determining granularity of the selected code blocks and reflecting the granularity to the metadata; and
selecting a location to which each of the code blocks is to be moved among empty space generated by movement of another code block and available page frames in the enclave.

17. The method of claim 14, wherein updating the instructions and the associated metadata entries includes
checking information about empty space generated by movement of a code block and information about space occupied by an operand of a source instruction of an inbound control flow to the target code block to be moved;
moving the selected code block to a selected memory location in the enclave;
updating a source block instruction of a control flow indicated by an outbound reference of metadata of the moved code block and metadata of a source block and a target block of the control flow;
updating a source block instruction of a control flow indicated by an inbound reference of the metadata of the moved code block and metadata of a source block and a target block of the control flow; and
updating information about empty space that is partially occupied after being generated by movement of the code block.

18. The method of claim 17, wherein moving the selected code block comprises adding an original memory region of the code block in space information metadata as empty space information and recording an occupied region along with range information thereof when the empty space is occupied by a trampoline instruction inserted thereinto due to movement of an additional code block or by an additional code block moved thereto.
